(19) United States
(12) Patent Application Publication
(10) Pub. No.: US 2019/0387791 A1
(43) Pub. Date: Dec. 26, 2019

(54) ELECTRONIC VAPORIZING APPARATUS

(71) Applicant: Airmyth Supply Company, LLC, Calabasas, CA (US)

(72) Inventors: Paul Pierce, Calabasas, CA (US); Elliot Mermel, Calabasas, CA (US)

(21) Appl. No.: 16/164,158

(22) Filed: Oct. 18, 2018

Related U.S. Application Data
(63) Continuation-in-part of application No. 29/654,385, filed on Jun. 22, 2018.
Application No. 29/654,385 is a continuation-in-part of application No. 29/654,386, filed on Jun. 22, 2018.
Application No. 29/654,386 is a continuation-in-part of application No. 29/654,388, filed on Jun. 22, 2018, now Pat. No. D864475.
(60) Provisional application No. 62/688,932, filed on Jun. 22, 2018.

(51) Int. Cl. A24F 47/00; H02J 7/00; A24D 1/14; H01M 2/10

(52) U.S. Cl. CPC A24F 47/008; H01M 2/1055; A24D 1/14; H02J 7/0047

(57) ABSTRACT

An electronic vaping apparatus is provided. A converter comprises a body comprising a top end comprising a receiver cavity, and a female threaded receiver located in the receiver cavity. The converter further comprises a bottom end opposite to the top end, the bottom end comprising a converter electrical port. The converter further comprises a first electrical connector extending from the converter electrical port and terminating in the receiver cavity. The female threaded receiver has a shape corresponding to, and configured to engage with, a male threaded screw of a cartridge. The first electrical connector terminating in the receiver cavity is configured to couple with a cartridge electrical port of the cartridge, when the cartridge is coupled to the receiver cavity by screwing in the male threaded screw of the cartridge into the female threaded receiver of the converter, completely.

### CROSS-REFERENCE TO RELATED APPLICATIONS

This application claims the benefit of the U.S. Provisional Application Ser. No. 62/688,932 filed on Jun. 22, 2018; and U.S. Design applications Serial Nos. 29/654,385, 29/654,386 and 29/654,388, each filed on Jun. 22, 2018, and the entirety of each of the applications above is herein incorporated by reference in its entirety.

### FIELD

Embodiments of the present invention generally relate to electronic vaporizing devices, and particularly to an electronic vaporizing apparatus comprising a converter.

### DESCRIPTION OF RELATED ART

Electronic vaporizing devices (“vaping devices”) have gained significant popularity as a recreational inhalation tool. Such devices are usually handheld, and work by heating a liquid to generate vapors, or otherwise rendering the liquid aerosol, generally referred to as “vapor,” which the user inhales. The liquid is also referred to as “e-liquid,” “e-juice,” “vaping liquid,” “vaping fluid” among several other popular names, and usually includes one or more of nicotine, propylene glycol, glycerin, or flavorings.

Some electronic vaporizing devices comprise a power (or battery) unit, a heating unit and a tank comprising the vaping liquid. The battery unit supplies electrical power to the heating unit to vaporize the vaping liquid stored in the tank, and the resulting vapor is directed through a mouthpiece to a user of the vaping device. In some configurations, the heating unit and the tank are combined into a single unit as a cartridge, which can be removably coupled to the power unit.

Due to the widespread popularity and proliferation, the vaping devices or components thereof are made in diverse styles and shapes by one manufacture, and such devices or components are generally not usable with components of another manufacturer.

Therefore, there exists a need for an improved vaporizing apparatus which enhances compatibility between different components.

### SUMMARY

The present invention provides an electronic vaporizing apparatus, substantially as shown in and/or described in connection with at least one of the figures, as set forth more completely in the claims. In one embodiment, a converter comprises a body comprising a top end comprising a receiver cavity, and a female threaded receiver located in the receiver cavity. The converter further comprises a bottom end opposite to the top end, the bottom end comprising a converter electrical port. The converter further comprises a first electrical connector extending from the converter electrical port and terminating in the receiver cavity. The female threaded receiver has a shape corresponding to, and configured to engage with, a male threaded screw of a cartridge. The first electrical connector terminating in the receiver cavity is configured to couple with a cartridge electrical port of the cartridge, when the cartridge is coupled to the receiver cavity by screwing in the male threaded screw of the cartridge into the female threaded receiver of the converter, completely.

In one embodiment, an apparatus comprises a converter installed in a power unit. The power unit comprises a body comprising a top face and a bottom face opposite to the top face. The top face comprises an opening having a shape complementary to, and configured to receive, the bottom portion of the converter. The opening comprises a power unit electrical port located in the opening, corresponding to the location of the converter electrical port, when the bottom portion of the converter is inserted into the opening. The opening also comprises a power unit magnetic portion comprising a second magnetic material disposed in the opening at positions that correspond to the position at which the first magnetic material of the converter is disposed, when the bottom portion of the converter is inserted into the opening. The power unit also comprises a battery located inside the power unit body, the battery is electrically coupled to the power unit electrical port, and the power unit electrical port is configured to couple electrically with the converter electrical port.

In one embodiment, an apparatus comprises a cartridge for being installed in a power unit. The cartridge comprises a tank for containing a vaping liquid, wherein the tank comprises a heating chamber. The cartridge comprises a top end comprising a vapor exit hole, a bottom portion comprising a bottom end opposite to the top end, the bottom end comprising a cartridge electrical port, and an insertion portion of the cartridge extending from the bottom end towards the top end. The cartridge further comprises a cartridge magnetic portion comprising a third magnetic material disposed in at least one of the bottom end, or the insertion portion. The cartridge also includes a second electrical connector extending from the cartridge electrical port and terminating in the heating chamber, where the second electrical connector supplies power to the heating chamber.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an electronic vaporizing apparatus, according to an embodiment of the present invention.

FIGS. 2A, 2B and 2C depict, respectively, a top perspective view, a bottom view and a cross section view of a converter, according to an embodiment of the present invention.

FIGS. 3A and FIG. 3B depict, respectively, a perspective view and a top view of a power unit, according to an embodiment of the present invention.

FIG. 4 depicts a first cartridge for use in the electronic vaporizing apparatus of FIG. 1, according to an embodiment of the present invention.

FIGS. 5A, 5B and 5C depict, respectively, a top perspective view, a bottom view and a cross section view of a second cartridge, according to an embodiment of the present invention.

FIG. 6 depicts an electronic vaporizing apparatus, according to an embodiment of the invention.

### DETAILED DESCRIPTION

Embodiments of the present invention generally relate to an electronic vaporizing apparatus and components thereof. The apparatus includes a converter for use with a power unit. The converter includes a receiver cavity having a female threaded receiver, for example, a 510 female threaded receiver for removably coupling with cartridges having male threaded screw, for example, a 510 male threaded screw. A cartridge can be screwed into the first cavity of the converter, and is held in place in the converter via the screw mechanism. Electrical ports are disposed within the receiver cavity of the converter and on the cartridge, and the electrical ports which come into contact with each other when the cartridge is screwed into the receiver cavity of the converter. The power unit has an opening for receiving the converter. In some embodiments, the converter is secured in the opening of the power unit via magnetic elements disposed on the converter and in the opening of the power unit. Electrical ports are disposed within the opening of the power unit and on the converter, and the electrical ports come into contact with each other when the converter is placed and secured within the opening of the power unit, and provide an electrical connection between the power unit and the converter. When the cartridge is screwed in the receiver cavity of the converter, and the converter is inserted into the opening of the power unit, the converter enables an electrical connection between the power unit and the cartridge, enabling the operation of the cartridge, for example, by enabling vaporization of the vaping liquid in the cartridge.

Cartridges generally comprise a tank for holding a vaping liquid, and a heating chamber to generate vapor from the vaping liquid. When the heating chamber of the cartridge is provided with electrical power, for example, from the power unit, the heating chamber generates the vapor. Cartridges come in different shapes and sizes. As described above, generic cartridges, for example cartridges having threaded screws (e.g., 510 threaded screws) can be used with the converter of the electronic vaporizing apparatus described herein. In addition, other embodiments of cartridges that can be used with the electronic vaporizing apparatus are described below. Specifically, direct insertion cartridges that do not require the use of the converter may be used with electronic vaporizing apparatus. The direct insertion cartridges include a portion insertable into the first opening of the power unit, in a manner similar to that of the converter, and comprise electrical contacts and magnetic elements corresponding to those disposed in the opening of the power unit. When the direct insertion cartridge is inserted into the opening of the power unit (directly, without the converter), the direct insertion cartridge can draw electrical power directly from the power unit to generate vapor from the vaping liquid in the direct insertion cartridge.

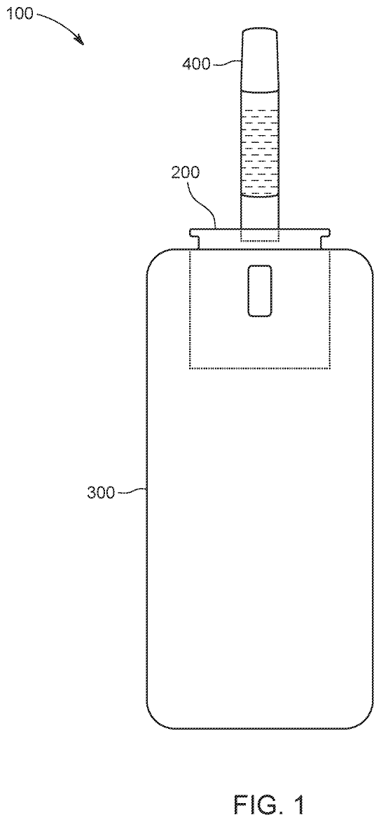

FIG. 1 depicts an electronic vaporizing apparatus 100, according to an embodiment of the present invention. The electronic vaporizing apparatus 100 comprises a converter 200, a power unit 300 and a first cartridge 400. The converter 200 is installed into the power unit 300, and the first cartridge 400 installed into the converter 200.

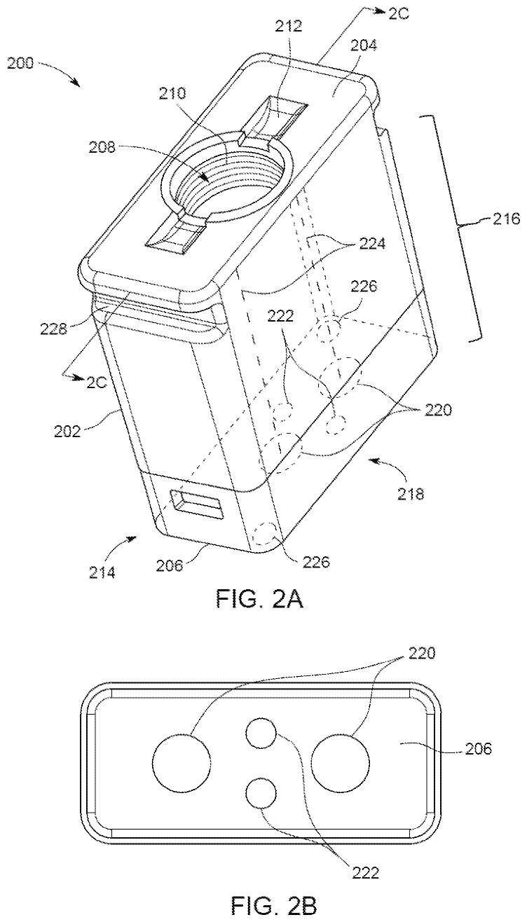

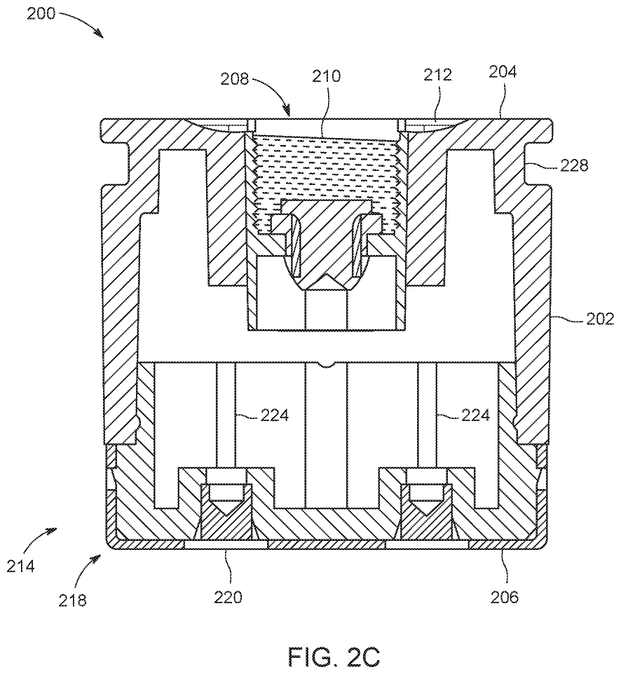

FIGS. 2A, 2B and 2C depict, respectively, a top perspective view, a bottom view and a cross section view of a converter, for example, the converter 200, according to an embodiment of the present invention.

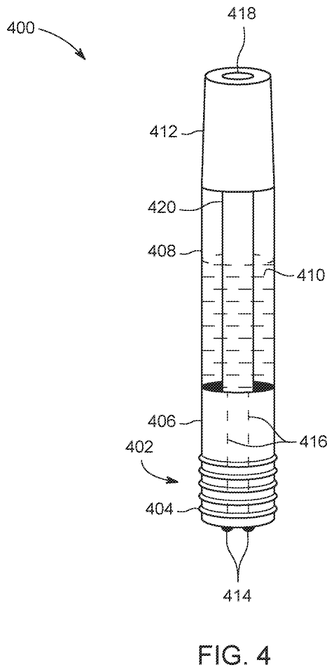

The converter 200 comprises a body 202 having a top end 204, and a bottom end 206 opposite the top end 204. The top end 204 comprises a receiver cavity 208, a female threaded receiver 210 located in the receiver cavity 208, and at least one air hole 212. The air holes 212 allow for a user of the apparatus to pull air through the cartridge, in order to inhale the contents of the cartridge. In one embodiment the receiver 210 is a 510 female threaded receiver 210. The 510 female threaded receiver 210 is configured to mate with a corresponding 510 male threaded screw located in a threaded portion of a cartridge, for example, the first 400 (described with respect to FIG. 4). Any cartridge having a 510 male threaded screw and a diameter of the threaded portion having a size matching the size of the 510 threaded female receiver 210 is usable with the converter 200. In some embodiments, the 510 thread includes ten threads at 0.5 mm per thread, and a diameter is 7 mm. In some embodiments, different dimensions of thread (and threaded receiver) other than the 510 thread may be utilized.

The bottom end 206 comprises a converter electrical port 220 and air holes 222. The air holes 222 facilitate the flow of air through the converter 200. The converter electrical port 220 is configured to couple electrically with corresponding electrical ports of the power unit 300, when the convertor 200 is installed by insertion into the power unit 300. The converter 200 comprises a first electrical connector 224, which extends from the converter electrical port 220 and terminates via a terminal (not shown) in the receiver cavity 208. The electrical connector includes one or more of conducting wires, conducting plates, and other generally known components for making electrically conductive connections between any two points.

The body 202 comprises a bottom portion 214, which comprises the bottom end 206. An insertion portion 216 extends from the bottom end 206 toward the top end 204. The insertion portion 216 spans a portion of the body 202, and in some embodiments, the insertion region spans up to 90 percent of the height of the body 202 from the bottom end 206, for example, as seen in FIG. 1. In some embodiments, the insertion region 216 spans between 75 to 90 percent of the height of the body 202 from the bottom end 206. In some embodiments, the insertion region 216 spans 10 to 25 percent of the height of the body 202. A converter magnetic portion 218 includes a first magnetic material disposed in the bottom portion 214, that is, in the bottom end 206, the insertion portion 216, or in both. The first magnetic material has magnetic properties capable of exerting magnetic force at a nearby magnetic object. The magnetic materials include one or more of Neodymium, Iron, Boron, Cobalt, Aluminum, Nickel, a ceramic, or a ferrite. In an embodiment, the bottom portion 214 includes non-magnetic material such as plastics, glass, fiber or non-magnetic, and certain portions of the bottom portion 214 include magnetic materials having magnetic properties. For example, the non-magnetic material may be impregnated with magnetic material, magnetic material may be embedded in gaps in the non-magnetic material, magnetic material may be positioned behind the non-magnetic material, or a combination of any one of the above. In an embodiment, the entire bottom portion 214 is made of magnetic materials.

In one embodiment, the first magnetic material is disposed in converter magnetic portion 226. The converter magnetic portion 226 and a corresponding magnetic portion of the power unit 300 are configured to couple magnetically to each other, when the convertor 200 is installed by insertion into the power unit 300. Further, the terminal of the first electrical connector 224 is configured to couple electrically with an electrical port of a cartridge (e.g. the cartridge 400), when the cartridge is installed in the receiver cavity 208. In this manner, the converter electrical port 220 and the first electrical connector 224 is configured to supply power received from the power unit 300 at the converter electrical port 220, to the electrical port of an installed cartridge.

The body 202 has a generally cuboid shape. In other embodiments, the body 202 may have other shapes shape including one or more of a cuboid, cube, sphere, cylinder, or other regular or irregular shapes. The body 202 is made from one or more of plastic, metal, glass, fiber, polymer, or a combination thereof. The body 202 may be a unitary module, or may be composed of two or more parts joined together by means of one or more coupling mechanisms, as generally known in the art. The converter 200 comprises one or more protrusions or apertures, for example, pull out notches 228 on either side of the body 202, for enabling a grip for fingertips of a user to pull-out the inserted converter 200 from the power unit 300.

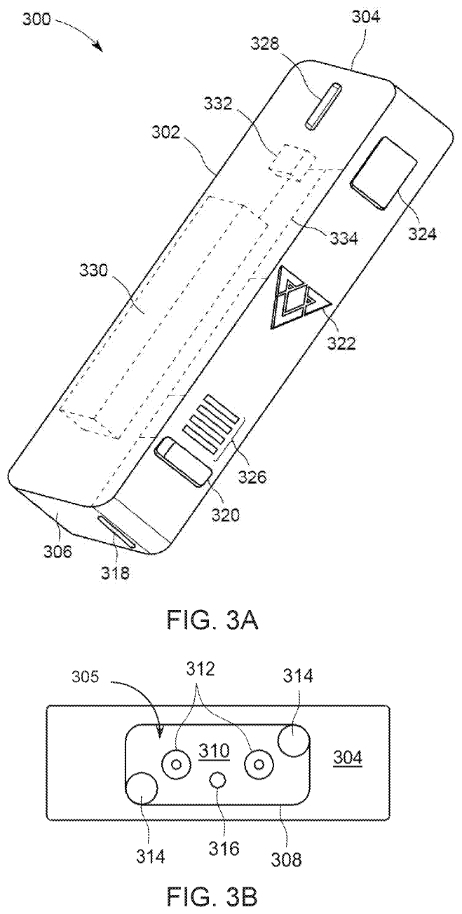

FIGS. 3A and FIG. 3B depict, respectively, a perspective view and a top view of a power unit 300, for example, the power unit 300, according to an embodiment of the present invention. The power unit 300 comprises a body 302, which includes a top face 304, and a bottom face 306 opposite to the top face 304. The top face 304 includes a cavity 305 comprising an opening 308 and a base 310 of the cavity 305, as seen more clearly in FIG. 3B. The base 310 comprises a power unit electrical port 312, a power unit magnetic portion 314, and an air hole 316.

The bottom face 306 includes a charging port 318. The power unit 300 also includes a power switch 320, a voltage button 322, a vapor button 324, a visual indicator 326, and a window 328 for providing visual access to the cavity 305. The power unit 300 also comprises a battery 330 and a controller 332 inside the body 302. The charging port 318, the power switch 320, the voltage button 322, the vapor button 324, the visual indicator 326, the battery 330 and the controller 332 are coupled via wires 334 or other electrical connectors 334 known in the art.

The cavity opening 308 of the power unit 300 has a shape complementary to the bottom portion 214 of the converter 200, and the cavity opening 308 is configured to receive the insertion portion 216 of the converter 200 in the cavity 305 via the opening 308. The power unit magnetic portion 314 comprises second magnetic material, which includes one or more of Neodymium, Iron, Boron, Cobalt, Aluminum, Nickel, a ceramic, or a ferrite. The power unit magnetic portion 314 is positioned in the cavity 305 to couple magnetically with the converter magnetic region 226, thereby coupling the converter 200 magnetically to hold the converter in place when the converter 200 is inserted in the cavity 305. The power unit electrical port 312 is positioned in the cavity 305 to couple electrically to the converter electrical port 220 of the converter 200, when the converter 200 is inserted in the cavity 305.

When the converter 200 is inserted fully into the cavity 305 via the opening 308, for example, such that the notches 228 of the converter 200 remain above the opening 308, the converter magnetic region 226 of the converter 200 is magnetically coupled to the power unit magnetic region 314 of the power unit 300. The magnetic coupling between the power unit 300 and the converter 200 has a force sufficient to hold the converter 200 in the cavity 320 to maintain the electrical connection between the converter electrical port 220 and the power unit electrical port 312. The converter 200 can be pulled out of the cavity 320 of the power unit 300, by exerting a force greater than the magnetic coupling force, for example, by the user pulling from the notches 228 of the converter 200. The battery 330 is configured to supply electrical power to the power unit electrical port 312, which may then be supplied from the power unit electrical port 322 to the converter electrical port 220 of the converter 200, when the power unit electrical port 322 is coupled to the converter electrical port 220.

The battery 330 includes various batteries as generally known in the art. In one embodiment, the battery 330 is capable of providing power at varying voltage levels, for example, via a voltage regulator (not shown). The controller 332 includes a microprocessor, a microcontroller, or an application specific integrated circuit (ASIC). The controller 332 is coupled to one or more of the battery 330, the power button 320, the voltage button 322, the vapor button 324, the visual indicator 326, the charging port 318 and the power unit electrical port 312. The controller 332 is configured to manage one or more functions of the power unit 300 based on the inputs received via one or more of the power button 320, the voltage button 322, and the vapor button 324, and display the status of the power unit 300 via the visual indicator 326.

The power button 320 functions to power on and power off the power unit 302. For example, when the power button 320 is in an ON state, the battery 330 can supply electrical power to the power unit electrical port 312, and when the power button 320 is in an OFF state, the battery 330 cannot supply electrical power to the power unit electrical port 312. In one embodiment, the controller 332 regulates the power supply from the battery 330 to the power unit electrical port 312, in response to the state of the power button 320.

The voltage button 322 functions to control the level of voltage supplied from the battery 330 to the power unit electrical port 312. The battery 330 is capable of supplying discrete levels of voltage. Depending on a status of the voltage button 322, the battery 330 supplies a predetermined discrete level of voltage, and the voltage supplied by the battery 330 may be changed by using the voltage button 322. In an embodiment, the voltage button 322 may be illuminated in one or more colors depending on its operational state. The voltage button 322 may be pressed one or more times to change the voltage level, thereby changing the heat levels at which a vaping fluid is heated. In one embodiment, the controller 332 regulates the voltage levels and the visual indications in response to the manipulation of the voltage button 322. In an embodiment, the battery 330 and/or the power unit 300 is configured to supply a fixed voltage output.

The vapor button 324 controls starting and stopping of formation of vapor by functioning as a gate which allows the power supply from the battery 330 to the power unit electrical port 312 based on the state of the vapor button 324, when the power button 320 is in an ON state. In one embodiment, when the vapor button 324 is in a pressed state, the vapor button 324 allows the power supply from the battery 330 to the power unit electrical port 312, and when the vapor button 324 is released, the vapor button 324 stops the power supply from the battery 330 to the power unit electrical port 312. In one embodiment, pressing the vapor button 324 once, or a predetermined number of times (e.g. five times in rapid succession), starts the power supply from the battery 330 to start the vapor formation without needing to press and hold the vapor button 324. Thereafter, pressing the vapor button 324 again stops the power supply from the battery 330 to stop vapor formation. In this manner, manipulating the vapor button 324 establishes an electrical connection from the power unit 300 to the first cartridge 400 via the converter 200. In one embodiment, the controller 332 regulates the power supply from the power unit 300 to the converter 200 in response to the manipulation of the vapor button 324. In one embodiment, the air hole 316 allows for air intake to trigger automatic operation of the power unit. For example, such automatic operation enables automatic or button-less inhalation, instead of the user being required to keep the vapor button 324 pressed.

The one or more visual indicators 326 indicate a charging level of the battery 330, on/off status of the battery 330, and/or a voltage level supplied by the battery 330. The visual indicator 326 comprises one or more light sources as generally known in the art, capable of emitting different colors, or different intensities, among other variations, and switching pattern or color of the lights may be used to provide a visual indication regarding the operational state of the power unit 300. For example, the lights being turned on or off may indicate whether the power switch is in an on or off mode, the number of lights turned on may indicate a charging level of the battery 330, the color of the light being emitted by the indicators 326 may indicate a voltage level being supplied by the power unit, the indicators 326 indicate a status of battery by turning on a light for a predetermined duration when the device is turned on by using the power button 320, among several other visual indication schemes generally known in the art. In one embodiment, the controller 332 regulates the visual indication schemes displayed by the visual indicators 326. For example, the voltage level being supplied by the power unit 300 may be indicated using different colors of light emitted by the indicators 326, or by illuminating the voltage button 322 in different colors. In one embodiment, illuminating the voltage button 322 in a green light indicates 2.2 V, in an orange light indicates 3.0 V, and in a red light indicates 3.8 V.

The charging port 318 is used to receive power supply to charge the battery 330. In an embodiment, the charging port 318 is a micro Universal Serial Bus (micro-USB) charging port. The battery 330 of the power unit 300 may be charged by connecting a micro-USB charging wire to the charging port 318 and to an energy source, including a wall socket, a computer USB port, a power bank, among others.

FIG. 4 depicts a first cartridge 400, for example, the first cartridge 400 for use in the electronic vaporizing apparatus 100 of FIG. 1, according to an embodiment of the present invention.

The first cartridge 400 comprises a threaded portion 402 including male threaded screw 404, a heating chamber 406, a tank 408 capable of containing a vaping liquid 410, and a mouthpiece 412. The first cartridge 400 also comprises a first cartridge electrical port 414 in the proximity of the threaded portion 402, a second connector 416 electrically coupling the first cartridge electrical port 414 and the heating chamber 406, an exit hole 418 in the mouthpiece 412, and a vaping channel 420 for providing a fluid or vapor pathway between the tank 408 and the exit hole 418 for the vapor to exit therefrom.

In one embodiment, the first cartridge 400 is a 510 cartridge 400, and the screw 404 is a 510 male threaded screw 404. The threaded portion 402 is configured to couple mechanically to the female threaded receiver 210 of the converter 200 by engagement of the male threaded screw 404 with female threads of the receiver 210. When the threaded portion 402 is screwed in the receiver cavity 208 of the converter 200 completely, a first cartridge electrical port 414 of the cartridge 400 contacts, and couples electrically, with the first electrical connector 224 in the receiver cavity 208. In this manner, the converter electrical port 220 is electrically coupled to the first cartridge electrical port 414 via the first electrical connector 224.

The heating chamber 406 is configured to vaporize a vaping liquid 410 contained in a tank 408, using the electrical power received from the third electrical port 414. Vapors formed in the tank 408 travel through the vaping channel 420 to the exit hole 418, from where the vapor is available to a user of the apparatus 100.

In an embodiment, the apparatus 100 of FIG. 1 is assembled by installing the first cartridge 400 in the converter 200 by screwing in the first cartridge in the receiver cavity 208 of the converter 200, and installing the converter 200 in the power unit 300 by inserting the insertion portion 216 of the converter 200 in the cavity 305 of the power unit 300 to couple the converter magnetic portion 226 and the power unit magnetic portion 314. The assembly of the first cartridge 400 and the converter 200, or the converter 200 and the power unit 300 may be done in any order. In this manner, an electrical connection is formed, sequentially, between the battery 330 and the heating chamber 406, via power unit electrical port 312, the converter electrical port 220, the first electric connector 224, the first cartridge electric port 414 and the second connector 416. The electrical power from the battery 330 of the power unit 300 is supplied to the heating chamber 406 of the first cartridge 400. The power supply to the heating chamber 406 to generate vapors is controlled by the various input elements such as the buttons (320, 322 and 324) of the power unit 300.

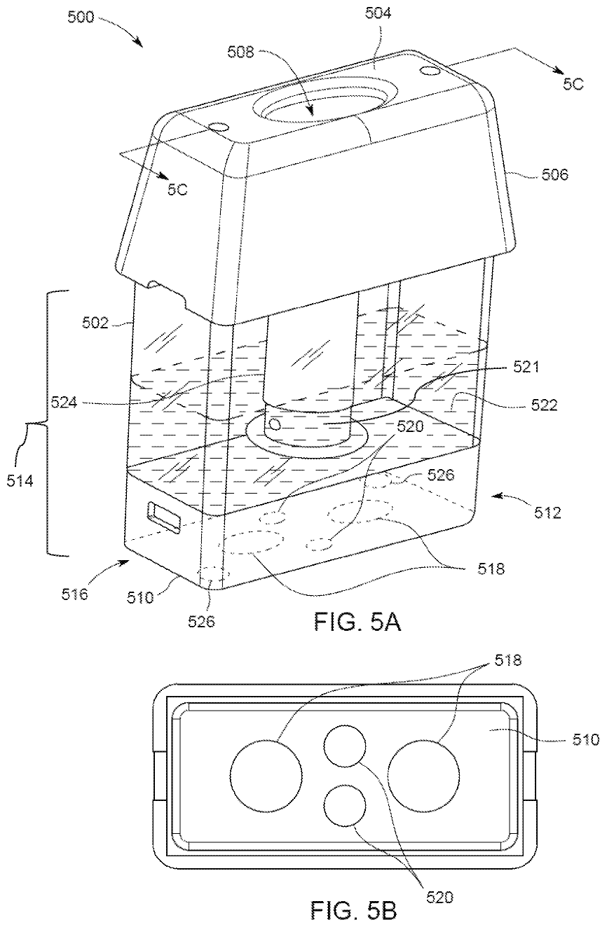

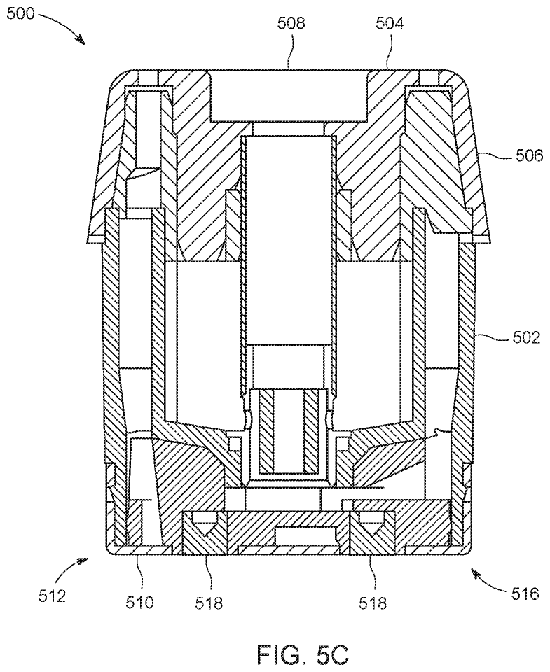

FIGS. 5A, 5B and 5C depict, respectively, a top perspective view, a bottom view and a cross section view of a direct insertion cartridge 500 or a second cartridge 500, according to an embodiment of the present invention. The second cartridge 500 is configured to be installed directly in the cavity 305 of the power unit 300, for example, when the converter 200 is not installed in the power unit 300. The second cartridge 500 includes a tank 502, a top end 504 comprised in a cap portion 506. The cap portion 506 and the bottom portion 510 encloses the tank 502. The top end 504 comprises an exit hole 508, for example, for the exit of vapors. The second cartridge 500 comprises a bottom end 510 opposite to the top end 504. The bottom end 510 is comprised in a bottom portion 512, which also comprises a second cartridge magnetic region 516, a second cartridge electrical port 518, and air holes 520. The tank 502 is configured to store a vaping liquid 522, and includes a heating chamber 521 to heat the vaping liquid 522, and a vaping channel 524 which provides a fluid pathway from the tank 502 to the exit hole 508. An insertion portion 514, spans a height of the second cartridge 500 up to the base of the cap portion 506, and the insertion portion 514 of the second cartridge 500 inserts completely into the cavity 305 up to the base of the cap portion 506, such that only the cap emerges out of the cavity 305 and above the opening 308 when the second cartridge 500 is properly installed in the power unit 300.

The second cartridge magnetic region 516 comprises a third magnetic material disposed in the bottom portion 512, including the bottom end 510, or in part of the insertion portion 514, or in both. The third magnetic material has magnetic properties capable of exerting magnetic force at a nearby magnetic object. The third magnetic materials include one or more of Neodymium, Iron, Boron, Cobalt, Aluminum, Nickel, a ceramic, or a ferrite. In an embodiment, the bottom portion 512 includes non-magnetic material such as plastics, glass, fiber or non-magnetic, and certain portions of the bottom portion 512 include magnetic materials having magnetic properties. For example, the non-magnetic material may be impregnated with magnetic material, magnetic material may be embedded in gaps in the non-magnetic material, magnetic material may be positioned behind the non-magnetic material, or a combination of any one of the above. In an embodiment, the entire bottom portion 512 is made of magnetic materials.

In an embodiment, the third magnetic material is disposed in a second cartridge magnetic portion 526. The second cartridge magnetic portion 526 is configured to couple magnetically to the power unit magnetic portion 314, when the second cartridge 500 is installed in the cavity 305 of the power unit 300. The second cartridge electrical port 518 is configured to couple electrically with the power unit electrical port 312, and receive electrical power therefrom. In an embodiment, the second cartridge electrical port 518 is configured to receive power from the power unit 300 to the heating chamber of the second cartridge 500. The heating chamber vaporizes the vaping liquid 522 contained in the tank 502 using the electrical power received from the second cartridge electrical port 518. Vapors formed in the tank 502 travel through the vaping channel 524 to the exit hole 508 in the top face 504, from where the vapor is available for intake, for example, by a user.

The second cartridge 500 generally has a cuboid shape. In other embodiments, the second cartridge 500 may have other shapes shape including one or more of a cuboid, cube, sphere, cylinder, or other regular or irregular shapes. The tank 502 is made from one or more of plastic, metal, glass, fiber, polymer, or a combination thereof. The second cartridge 500 may be a unitary module, or may be composed of two or more parts joined together by means of one or more coupling mechanisms, as generally known in the art. The second cartridge 500 comprises one or more protrusions or apertures, for example, the cap portion 506, edges of which enable a grip for fingertips of a user to pull-out the inserted second cartridge 500 from the power unit 300.

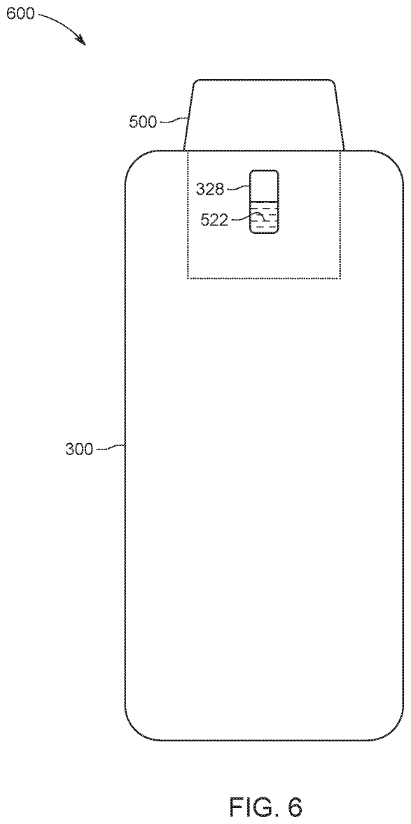

The bottom portion 512 of the second cartridge 500 is similar in shape to the bottom portion 214 of the converter 200, and compatible with the opening 308 and/or the cavity 305 of the power unit 300. The bottom portion 512 is configured to be electrically and magnetically coupled to the power unit 300, when the second cartridge 500 is installed in the power unit 300, for example, similar to the configuration of FIG. 1, in which the converter 200 and the first cartridge 400 are replaced by the second cartridge 500, for example as shown in FIG. 6. In an embodiment, the window 328 allows visibility of the level of the vaping liquid 522 in the tank 502 of the second cartridge 500, when the second cartridge 500 is installed in the power unit 300.

The embodiments described herein illustrate magnetic coupling between the power unit and the converter, or between the power unit and the direct insertion cartridges, however, the embodiments described herein are not limited to magnetic coupling. Other coupling mechanisms, such as snap-fit clips, insertion tabs, pressure fit mechanisms, screw mechanisms, among several others known in the art may also be used to achieve coupling between the power unit and the converter, or the power unit and the direct insertion cartridge, without departing from the scope and spirit of the present invention, as defined by the appended claims.

The embodiments described herein provide a versatile and convenient electronic vaporizing apparatus. The described embodiments enable the use of cartridges (first cartridge, e.g. 510 threaded cartridges) from different manufacturers using a converter with the power unit, as well as use of cartridges (second cartridge) compatible directly with the power unit, in a convenient manner.

All embodiments and examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

1. A converter comprising:
a body comprising
a top end comprising a receiver cavity, and a 510 female threaded receiver located in the receiver cavity, and
a bottom end opposite to the top end, the bottom end comprising a converter electrical port; and
a first electrical connector extending from the converter electrical port and terminating in the receiver cavity.

2. The converter of claim 1, wherein the receiver cavity is configured to receive a 510 cartridge,
wherein the 510 female threaded receiver has a shape corresponding to, and configured to engage with, a 510 male threaded screw of the 510 cartridge, and
wherein the first electrical connector terminating in the receiver cavity is configured to couple with a 510 cartridge electrical port of the 510 cartridge, when the 510 cartridge is installed to the receiver cavity by screwing in the 510 male threaded screw into the 510 female threaded receiver, completely.

3. The converter of claim 1, wherein the body further comprises
a bottom portion, the bottom portion comprising the bottom end,
an insertion portion of the body extending from the bottom end to the top end, and
a converter magnetic portion comprising a magnetic material disposed in at least one of the bottom end, or the insertion portion.

4. The converter of claim 3, wherein the insertion portion has a shape corresponding to, and configured to be inserted in, an opening of a power unit,
wherein the converter magnetic portion is configured to couple magnetically with a power unit magnetic portion of the power unit, the power unit magnetic portion located in the first opening, and
wherein the converter electrical port is located in the bottom portion to connect with a power unit electrical port located in the opening of the power unit, when the converter is installed into the power unit by inserting the bottom portion of the converter into the opening of the power unit, and the converter magnetic portion is magnetically coupled with the power unit magnetic portion.

5. The converter of claim 3, wherein the magnetic material comprises at least one of Neodymium, Iron, Boron, Cobalt, Aluminum, Nickel, a ceramic, or a ferrite.

6. An apparatus comprising:
a converter comprising:
a body comprising:
a top end comprising a receiver cavity, and a 510 female threaded receiver located in the receiver cavity,
a bottom portion comprising:
a bottom end opposite to the top end, the bottom end comprising a converter electrical port, and
a converter magnetic portion comprising a first magnetic material disposed in at least one of the bottom end or the insertion portion,
an insertion portion of the body, the insertion portion extending from the bottom end to the top end, and
a first electrical connector extending from the converter electrical port and terminating in the receiver cavity; and
a power unit comprising:
a body comprising a top face and a bottom face opposite to the top face, the top face comprising:
an opening having a shape complementary to, and configured to receive, the bottom portion of the converter, wherein the opening comprises:
a power unit electrical port located in the opening corresponding to a location of the converter electrical port, when the bottom portion of the converter is inserted into the opening, and
a power unit magnetic portion comprising a second magnetic material disposed in the opening at positions that correspond to the position at which the first magnetic material of the converter is disposed, when the bottom portion of the converter is inserted into the opening, and
a battery located inside the power unit body, the battery electrically coupled to the power unit electrical port,
wherein the power unit electrical port configured to couple electrically with the converter electrical port, and
wherein the first magnetic material of the converter magnetic portion is configured to couple magnetically with the second magnetic material of the power unit magnetic portion.

7. The apparatus of claim 6, wherein the first magnetic material comprises at least one of Neodymium, Iron, Boron, Cobalt, Aluminum, Nickel, a ceramic, or a ferrite, and wherein the second magnetic material comprises at least one of Neodymium, Iron, Boron, Cobalt, Aluminum, Nickel, a ceramic, or a ferrite.

8. The apparatus of claim 6, wherein the power unit further comprises:
a controller configured to manage a power supply between the battery and the power unit electrical port, manage a voltage level of the power supply, manage display of a status of the power supply or the voltage level, or a combination thereof.

9. The apparatus of claim 8, wherein the power unit further comprises a power button having states ON or OFF, wherein in the OFF state, the battery does not supply power to the power unit electrical port, and wherein in an ON state, the battery is capable of supplying power to the power unit electrical port.

10. The apparatus of claim 9, wherein the power unit further comprises a vapor button having states ON or OFF, wherein when the power button is in the ON state, and the vapor button is in the ON state, the battery supplies power to the power unit electrical port.

11. The apparatus of claim 8, wherein the power unit further comprises a voltage button having a plurality of states, wherein the battery supplies power to the power unit electrical port according to the state of the voltage button.

12. The apparatus of claim 8, wherein the power unit further comprises a visual indicator comprising at least one light source, wherein the at least one light source is capable of displaying light of different color, intensity, turning on or turning off, or a combination thereof, and wherein the at least one light source indicates a status of at least one of a power button, a voltage button, and a vapor button.

13. The apparatus of claim 8, wherein the receiver cavity is configured to receive a 510 cartridge,
wherein the 510 female threaded receiver has a shape corresponding to, and configured to engage with, a 510 male threaded screw of the 510 cartridge, and wherein the first electrical connector terminating in the receiver cavity is configured to couple with a 510 cartridge electrical port of the 510 cartridge, when the 510 cartridge is installed to the receiver cavity by screwing in the 510 male threaded screw into the 510 female threaded receiver, completely.

14. The apparatus of claim 13, further comprising the 510 cartridge, wherein the 510 cartridge is installed in the converter by screwing the 501 male threaded screw in the 501 female threaded receiver, and wherein the 510 cartridge electrical port is electrically coupled with the first electrical connector in the receiver cavity of the converter when the 510 cartridge is installed in the converter.

15. A cartridge for use with an electronic vaporizing apparatus comprising:
a tank for containing a vaping liquid, the tank comprising a heating chamber;
a top end comprising a vapor exit hole;
a bottom portion comprising
a bottom end opposite to the top end, the bottom end comprising a cartridge electrical port, and
a cartridge magnetic portion comprising a third magnetic material disposed in at least one of the bottom end, or the insertion portion,
an insertion portion of the cartridge extending from the bottom end to the top end; and
a second electrical connector extending from the cartridge electrical port and terminating in the heating chamber, the second electrical connector to supply power to the heating chamber.

16. The cartridge of claim 15, wherein the insertion portion has a shape corresponding to, and configured to be inserted in, an opening of a power unit,
wherein the cartridge magnetic portion is configured to couple magnetically with a power unit magnetic portion of the power unit, the power unit magnetic portion located in the opening, and
wherein the cartridge electrical port is located in the bottom portion to connect with a power unit electrical port located in the opening, when the cartridge is installed into the power unit by inserting the bottom portion of the cartridge into the opening of the power unit, and the cartridge magnetic portion is magnetically coupled with the power unit magnetic portion.

17. The cartridge of claim 16, wherein the third magnetic material comprises at least one of Neodymium, Iron, Boron, Cobalt, Aluminum, Nickel, a ceramic, or a ferrite.

18. The cartridge of claim 16, comprising a vaping channel having a fluid pathway from the tank to the vapor exit hole,
wherein the heating chamber is configured to receive electrical power when the cartridge is installed in the opening,
wherein the heating chamber is configured to heat the vaping liquid to generate a vapor upon receiving electrical power, and
wherein the vapor passes through the vaping channel and exits from the vapor exit hole.
